(19) United States
(12) Patent Application Publication
(10) Pub. No.: US 2015/0382081 A1
(43) Pub. Date: Dec. 31, 2015

(54) GENERATION OF VIDEO CONTENT

(71) Applicant: BlurbIQ, Inc., Las Vegas, NV (US)

(72) Inventors: Scott Reese, Las Vegas, NV (US); Andrew Spencer, Las Vegas, NV (US); Derrick Horner, Las Vegas, NV (US)

(21) Appl. No.: 14/750,745

(22) Filed: Jun. 25, 2015

Related U.S. Application Data
(60) Provisional application No. 62/018,235, filed on Jun. 27, 2014.

(51) Int. Cl. H04N 21/8543; G11B 27/036

(52) U.S. Cl. CPC H04N 21/8543; G11B 27/036

(57) ABSTRACT

Technology is described for generating video content. Source code associated with an electronic page may be received. The source code may be rendered at a browser rendering engine in order to create rendered content associated with the electronic page. One or more processes may be executed in order to capture a plurality of images of the rendered content, the one or more processes being executed according to a defined offset. The plurality of images may be aggregated in order to create video content.

### PRIORITY CLAIM

Benefit is claimed of and to U.S. Provisional Patent Application Ser. No. 62/018,235, filed Jun. 27, 2014, which is hereby incorporated herein by reference in its entirety.

### BACKGROUND

A number of tools may be available for creating video content. A user may create the video content and upload the video content to an electronic page. The video content may include promotional information or educational content. In one example, the user may purchase and/or download video creation and editing software in order to create the video content. Alternatively, the user may provide various files (e.g., images, audio files) to an online video creation tool. The online video creation tool may generate the video content based on the various files received from the user. For example, the video content may include a first image that is shown for X seconds, a second image that is shown for Y seconds, and so on.

### BRIEF DESCRIPTION OF THE DRAWINGS

FIG. 1 illustrates a system and related operations for generating video content according to an example of the present technology.

FIG. 2 is an illustration of a networked system for generating video content according to an example of the present technology.

FIG. 3 illustrates a user interface rendered by a client according to an example of the present technology.

FIG. 4 is a block diagram that provides an example illustration of a computing device that may be employed in the present technology.

### DETAILED DESCRIPTION

Technology is described for generating video content from a plurality of images. The plurality of images may be captured from a user session at an electronic page. In other words, a plurality of screenshots from the user session at the electronic page may be captured. The plurality of images may be weaved together to create the video content. As an example, if the video content is at 30 frames per second, then images from the user session may be captured every 1/30^{th} of a second, and the images may be weaved together to generate the video content. The video content may be uploaded to a video sharing electronic page or stored in a local data store.

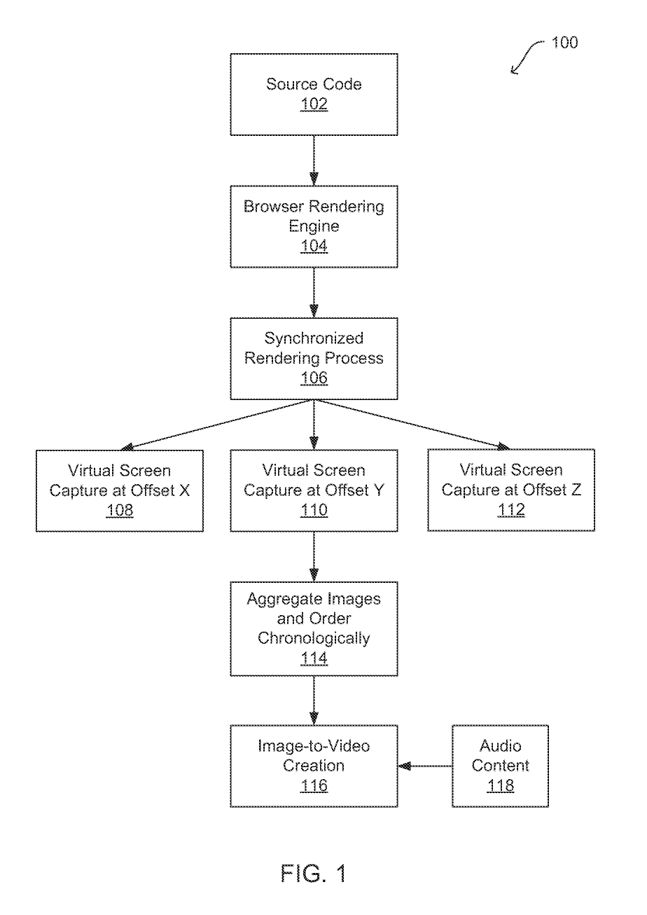

FIG. 1 illustrates a system 100 for generating video content. Source code 102 may be inputted into a browser rendering engine 104. The source code 102 may be associated with an electronic page. The electronic page may include, for example, a user's business website. The source code 102 may include, but is not limited to, hypertext markup language (HTML), JavaScript, extensible markup language (XML), and cascading style sheets (CSS). In addition, the source code 102 may include a combination of HTML, JavaScript, XML or CSS.

The browser rendering engine 104 (also known as a web browser engine or a layout engine) may receive the source code 102. In other words, the browser rendering engine 104 may receive marked up content (e.g., HTML, XML, image files) and formatting information (e.g., CSS). The browser rendering engine 104 may be embedded in web browsers, email clients, e-book readers, online help systems and other applications that require the editing and displaying of web content. The browser rendering engine 104 may be open source or proprietary.

A synchronized rendering process 106 may be performed at the browser rendering engine 104. The synchronized rendering process 106 may provide rendered content (e.g., web content) onto a display screen via a browser. The display screen may be associated with a desktop computer, laptop computer, mobile device, gaming device, television, etc. In one example, the browser rendering engine 104 may wait for all of the source code 102 to be received before performing the synchronized rendering process 106. Alternatively, the browser rendering engine 104 may begin the synchronized rendering process 106 before all of the source code 102 is received at the browser rendering engine 104. As a non-limiting example, when the user attempts to open the business webpage, the browser rendering engine 104 may render the source code 102 associated with the business webpage before providing the business webpage (i.e., the rendered content) for display on the user's screen.

In one configuration, an image or a plurality of images may be captured of the rendered content that is being provided to the display screen. In other words, one or more screenshots of the rendered content in the browser may be captured at the browser rendering engine 104. The images of the rendered content may be captured N times per second for a duration of D, wherein N and D are integers. For example, 30 images of the rendered content may be captured per second (i.e., N equals 30) for a duration of 5 minutes. In one example, capturing N images per second may exceed a processing capability of the browser rendering engine 104. Therefore, the browser rendering engine 104 may execute multiple processes simultaneously in order to capture N images per second. Each process may capture the images at an offset as compared with the other processes. As a result, N images can be successfully captured per second while using less processing power. For example, a first virtual screen capture may occur at Offset X 108, a second virtual screen capture may occur at Offset Y 110, and a third virtual screen capture may occur at Offset Z 112.

As an example, each process may capture images every ⅙^{th} of a second in order to capture 30 images per second for a duration of 5 minutes. Thus, five processes may be simultaneously executed in order to capture the 30 frames per second. However, each process does not begin at the same time. Rather, a first processes begins and then the second process begins at an offset after the first process. For example, the first process may capture images at 1, 6, 11, 16, 21 and 26. In other words, a first image is captured at 1/30^{th} of a second, a second image is captured at 6/30^{th} of a second, and so on. The second process may capture images at 2, 7, 12, 17, 22 and 27. Thus, the offset for the second process beginning may be 1/30^{th} of a second. A third process may capture images at 3, 8, 13, 18, 23 and 28. A fourth process may capture images at 4, 9, 14, 19, 24 and 29. A fifth process may capture images at 5, 10, 15, 20, 25 and 30. Therefore, between the five processes that are being simultaneously executed at the browser rendering engine 104, 30 images of the rendered content may be collectively captured per second.

The browser rendering engine 104 may aggregate the plurality of images and chronologically order the images, as shown in block 114. In one example, the images may have been taken every 1/30^{th} of a second for the rendered content for a duration of 5 minutes. Therefore, a total of 150 images may be stored at the browser rendering engine, but the 150 images may be out of order. For example, the images captured for a given second may be ordered 1, 6, 11, 16, 21, 26, 2, 7, 12, 17, 22, 27, and so on. The browser rendering engine 104 may aggregate the images and chronologically order the images, such that the images are ordered 1, 2, 3, 4, 5, 6, and so on.

The plurality of images that are aggregated and chronologically ordered may be used to generate video content, as shown in block 116. In other words, the images may be weaved together in order to create the video content. Since the images are automatically captured, the user does not have to manually provide images for creating the video content. As an example, the video content may include 20 images (i.e., screenshots) per second for the duration of the video content. The video content may be exported to a preferred file format (e.g., WMV, MOV, AVI, MPG4, MPEG, and AVI) and saved to a local hard drive. Alternatively, the video content may be uploaded to an electronic page. In one example, the images may be weaved together using FFmpeg or similar types of software.

In one example, audio content 118 may be included in the video content. For example, an audio file may be synchronized with the video content. The audio file may be music, an advertisement, a tutorial, etc. The audio file may be uploaded from a personal computing device when the video content is being created. Alternatively, the audio content 118 may be recorded using a microphone and then included in the video content. In addition, the video content may include text for specific portions or all of the video content.

In one configuration, HTML headers and HTML page text associated with the electronic page (i.e., the rendered content) being provided to the display screen may be parsed and used to automatically embed metadata for the video content. Contextual analysis may be performed on the keywords of the electronic page and used to automatically embed category or context metadata for the video content. In addition, semantic extraction of entities from the electronic page may be performed and then used in order to automatically embed person/place/thing metadata for the video content. In one example, a Video Player Ad-Serving Interface Definition (VPAID) layer may be used to active clickable regions on the video content, i.e., the video of an HTML page may behave similar to the HTML page.

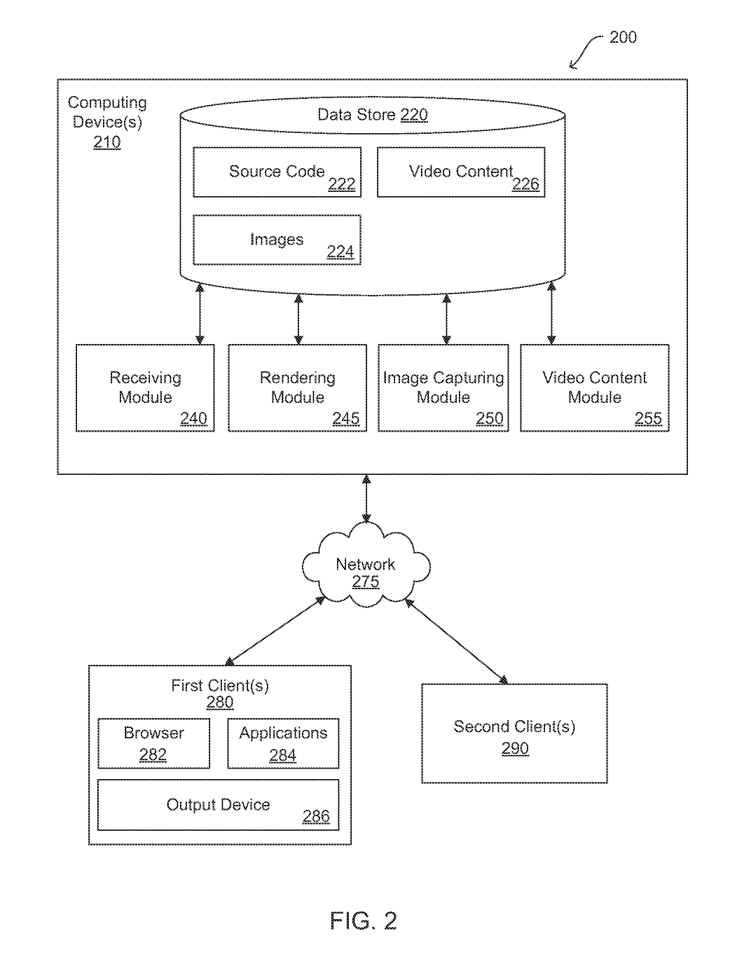

In the following discussion, a general description of an example system for generating video content and the system's components are provided. The general description is followed by a discussion of the operation of the components in a system for the technology. FIG. 2 illustrates a networked environment 200 according to one example of the present technology. The networked environment 200 may include one or more computing devices 210 in data communication with a first client 280 and a second client 290 by way of a network 275. The network 275 may include the Internet, intranets, extranets, wide area networks (WANs), local area networks (LANs), wired networks, wireless networks, or other suitable networks, etc., or any combination of two or more such networks.

Various applications, services and/or other functionality may be executed in the computing device 210 according to varying embodiments. Also, various data may be stored in a data store 220 that is accessible to the computing device 210. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The data stored in the data store 220, for example, may be associated with the operation of the various applications and/or functional entities described below.

The data stored in the data store 220 may include source code 222. The source code 222 may be associated with an electronic page. For example, the electronic page may be associated with a user's business website. The source code 222 may include, but is not limited to, HTML, CSS, JavaScript, XML or PHP. In addition, the source code 222 may include a combination of HTML, JavaScript, XML, PHP, or CSS.

The data stored in the data store 220 may include images 224. The images 224, also known as screenshots, may be captured of rendered content provided to a display screen. The images 224 may be captured N times per second for a duration of D, wherein N and D are integers. For example, the images 224 may be captured 20 times per second for a duration of 1 minute. The file format associated with the images 224 may include, but are not limited to, JPG, PNG, or GIF.

The data stored in the data store 220 may include video content 226. The video content 226 may be created from a plurality of images 224. The video content 226 may be related to content rendered in a browser. For example, the video content 226 may be related to a user's business website. The video content 226 may be an advertisement or tutorial related to the user's business website. The video content 226 may include text and/or audio. The video content 226 may be at a defined frame rate (e.g., 20 frames per second). The defined frame rate may correspond to the N times per second that the images 224 are captured of the rendered content. The video content 226 may be downloaded to a local hard drive (e.g., the user's personal computer) or uploaded to an electronic page (e.g., the user's business website or a video sharing website).

The components executed on the computing device 210 may include a receiving module 240, a rendering module 245, an image capturing module 250, a video content module 255, and other applications, services, processes, systems, engines, or functionality not discussed in detail herein. The receiving module 240 may be configured to receive source code 222 associated with an electronic page. The source code 222 may include at least one of C++, JavaScript, CSS, XML or HTML.

The rendering module 245 may be configured to render the source code 222 at a browser rendering engine in order to create rendered content associated with the electronic page. In other words, the rendering module 245 may render webpages or other types of web content in a browser. The browser rendering engine may also be known as a layout engine or a web browser engine. The browser rendering engine may be embedded in web browsers, email clients, e-book readers, online help systems and other applications that require the editing and displaying of web content. The browser rendering engine may be open source or proprietary.

The image capturing module 250 may be configured to execute one or more processes in order to capture a plurality of images 224 of the rendered content, the one or more processes being executed according to a defined offset. The plurality of images 224 may be captured at a defined rate and for a defined duration. As a non-limiting example, the images 224 of the rendered content may be captured 15 times per second for a duration of two minutes. In addition, five processes may be executed simultaneously to capture the 15 images per second. Each of the five processes may begin capturing the images 224 according to the defined offset. For example, a first process may capture image 1, a second process may capture image 2, and so on. In addition, the first process may capture image 6, the second process may capture image 7, and so on.

The video content module 255 may be configured to aggregate the plurality of images 224 in order to create video content 226. In addition, the video content module 255 may chronologically order the plurality of images 224 when creating the video content 226. The video content 226 may include audio and/or text. The video content 226 may be provided according to a defined frame rate (e.g., 20 frames per second). In one example, the video content 226 may be uploaded to an electronic page.

Certain processing modules may be discussed in connection with this technology and FIG. 2. In one example configuration, a module of FIG. 2 may be considered a service with one or more processes executing on a server or other computer hardware. Such services may be centrally hosted functionality or a service application that may receive requests and provide output to other services or customer devices. For example, modules providing services may be considered on-demand computing that are hosted in a server, cloud, grid, or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

The computing device 210 may comprise, for example, a server computer or any other system providing computing capability. Alternatively, a plurality of computing devices 210 may be employed that are arranged, for example, in one or more server banks, computer banks or other computing arrangements. For example, a plurality of computing devices 210 together may comprise a clustered computing resource, virtualization server, a grid computing resource, and/or any other distributed computing arrangement. Such computing devices 210 may be located in a single installation or may be distributed among many different geographical locations. For purposes of convenience, the computing device 210 is referred to herein in the singular. Even though the computing device 210 is referred to in the singular, it is understood that a plurality of computing devices 210 may be employed in the various arrangements as described above.

The first client 280 and the second client 290 are representative of a plurality of client devices that may be coupled to the network 275. The first client 280 and the second client 290 may comprise, for example, a processor-based system such as a computer system. Such a computer system may be embodied in the form of a desktop computer, a laptop computer, personal digital assistants, cellular telephones, smartphones, set-top boxes, network-enabled televisions, music players, tablet computer systems, game consoles, electronic book readers, or other devices with like capability.

The first client 280 may be configured to execute various applications such as a browser 282, and/or other applications 284. The applications 284 may correspond to code that is executed in the browser 282 (e.g., web applications). The applications 284 may also correspond to standalone applications, such as networked applications. In addition, the client 280 may be configured to execute applications 284 that include, but are not limited to, shopping applications, video playback applications, standalone applications, email applications, instant message applications, and/or other applications. In addition, the second client 290 may also include a browser and/or applications (not shown in FIG. 2).

The first client 280 may include or be coupled to an output device 286. The browser 282 may be executed on the first client 280, for example, to access and render network pages (e.g. web pages) or other network content served up by the computing device 210 and/or other servers. The output device 286 may comprise, for example, one or more devices such as cathode ray tubes (CRTs), liquid crystal display (LCD) screens, gas plasma-based flat panel displays, LCD projectors, or other types of display devices, etc. In addition, the output device 286 may include an audio device, tactile device (e.g., braille machine) or another output device to feedback to a user. In addition, the second client 290 may also include an output device (not shown in FIG. 2).

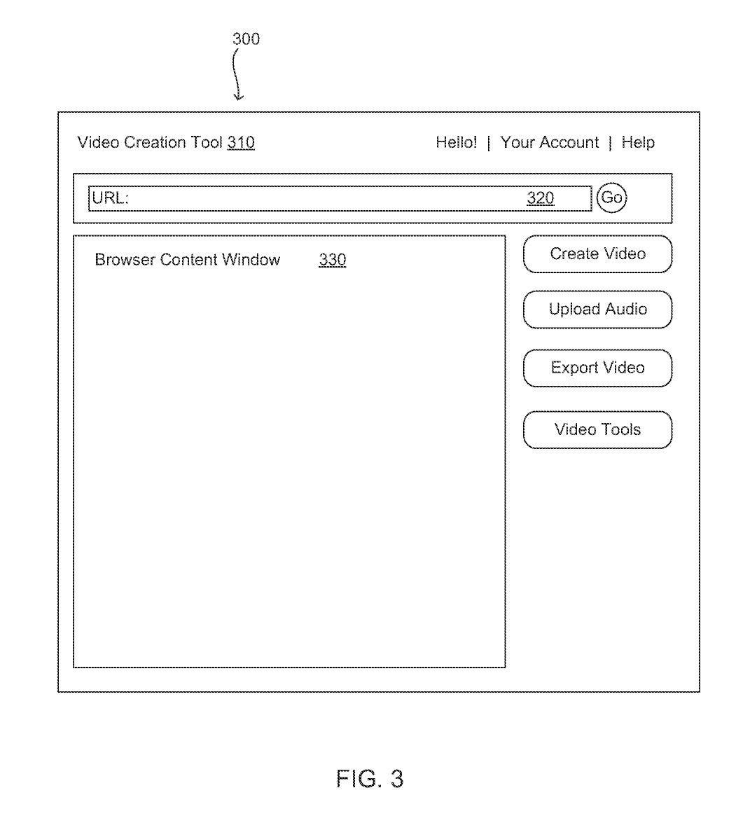

FIG. 3 illustrates an exemplary user interface 300 rendered by a client. The user interface 300 may be for a video creation tool 310. A user may access the video creation tool 310 by entering an address into a browser and logging into the user's account. Alternatively, the user may access the video creation tool 310 via an application running on the user's computing device. The user may enter a uniform resource locator (URL) 320 for an electronic page after opening to the video creation tool 310. In one example, the URL 320 for the electronic page may be associated with a business (e.g., an electronic retail store) operated by the user.

The electronic page may be provided in the browser content window 330 of the user interface 300. Source code (e.g., HTML, CSS, JavaScript) associated with the electronic page may be rendered and provided for display in the browser content window 330. In other words, rendered content may be provided to the browser content window 330. The user may create video content based on the electronic page displayed in the browser content window 330. For example, the user may enter instructions into the user interface 300 to create 30 seconds of video content from the browser content window 330. The user may specify a number of frames per second for the video content. In addition, the user may specify a portion of the browser content window 330 that is to be captured for the video content. The portion of the browser content window 330 may include substantially the entire browser content window 330.

When the video content is being created from the browser content window 330, a plurality of images (or screenshots) may be captured of the browser content window 330. For example, 20 images may be captured per second in order to create video content that is 20 frames per second. In one configuration, multiple processes may be executed simultaneously in order to capture the 20 images per second. The plurality of images may be weaved together to create the video content. In one example, the user interface 300 may include options to add audio content to the video content, export the video content and/or access video tools related to the generation of the video content.

As a non-limiting example, the user may access the URL for an electronic page related to the user's antique furniture store. The user may desire to create a video advertisement discussing promotions and deals at the antique furniture store. The user may instruct the video creation tool 310 for 30 seconds of video content to be captured from the electronic page. In addition, the user may use a microphone to capture audio content discussing the antique furniture store. The 30 seconds of video content may be created, along with the audio content, and uploaded to the user's electronic page. Therefore, the user is provided with a simple and cost-efficient service for generating videos based on content rendered in a browser, and then the ability to upload or save the videos to a number of destinations (e.g., websites, local hard drives, USB device).

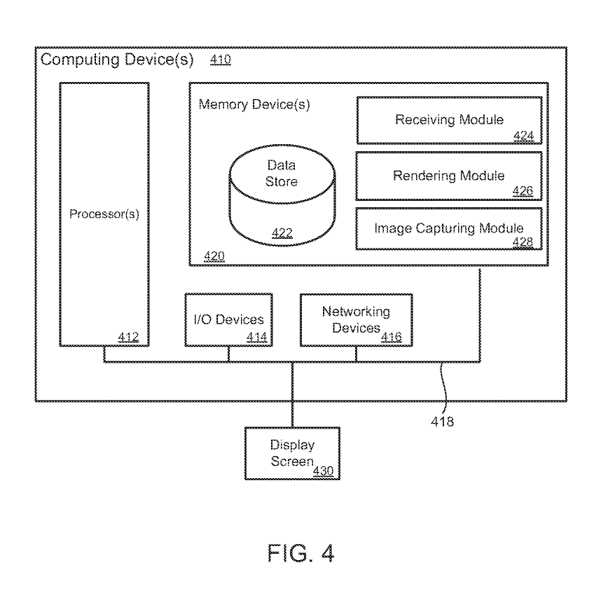

FIG. 4 illustrates a computing device 410 on which modules of this technology may execute. A computing device 410 is illustrated on which a high level example of the technology may be executed. The computing device 410 may include one or more processors 412 that are in communication with memory devices 420. The computing device may include a local communication interface 418 for the components in the computing device. For example, the local communication interface may be a local data bus and/or any related address or control busses as may be desired.

The memory device 420 may contain modules that are executable by the processor(s) 412 and data for the modules. Located in the memory device 420 are modules executable by the processor. For example, a receiving module 424, a rendering module 426, an image capturing module 428, and other modules may be located in the memory device 420. The modules may execute the functions described earlier. A data store 422 may also be located in the memory device 420 for storing data related to the modules and other applications along with an operating system that is executable by the processor(s) 412.

Other applications may also be stored in the memory device 420 and may be executable by the processor(s) 412. Components or modules discussed in this description that may be implemented in the form of software using high programming level languages that are compiled, interpreted or executed using a hybrid of the methods.

The computing device may also have access to I/O (input/output) devices 414 that are usable by the computing devices. An example of an I/O device is a display screen 430 that is available to display output from the computing devices. Other known I/O device may be used with the computing device as desired. Networking devices 416 and similar communication devices may be included in the computing device. The networking devices 416 may be wired or wireless networking devices that connect to the internet, a LAN, WAN, or other computing network.

The components or modules that are shown as being stored in the memory device 420 may be executed by the processor 412. The term “executable” may mean a program file that is in a form that may be executed by a processor 412. For example, a program in a higher level language may be compiled into machine code in a format that may be loaded into a random access portion of the memory device 420 and executed by the processor 412, or source code may be loaded by another executable program and interpreted to generate instructions in a random access portion of the memory to be executed by a processor. The executable program may be stored in any portion or component of the memory device 420. For example, the memory device 420 may be random access memory (RAM), read only memory (ROM), flash memory, a solid state drive, memory card, a hard drive, optical disk, floppy disk, magnetic tape, or any other memory components.

The processor 412 may represent multiple processors and the memory 420 may represent multiple memory units that operate in parallel to the processing circuits. This may provide parallel processing channels for the processes and data in the system. The local interface 418 may be used as a network to facilitate communication between any of the multiple processors and multiple memories. The local interface 418 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for generating video content, the method comprising:
under control of one or more computer systems configured with executable instructions:
receiving source code associated with an electronic page;
rendering the source code at a browser rendering engine in order to create rendered content associated with the electronic page;
executing one or more processes in order to capture a plurality of images of the rendered content, the one or more processes being executed according to a defined offset; and
aggregating the plurality of images in order to create video content.

2. The method of claim 1, further comprising providing the video content according to a defined frame rate.

3. The method of claim 1, further comprising uploading the video content to an electronic page.

4. The method of claim 1, wherein the source code is at least one of: JavaScript, CSS, or HTML.

5. The method of claim 1, wherein the plurality of images are captured for a defined duration.

6. The method of claim 1, further comprising adding audio content to the video content.
